(19) United States
(12) Patent Application Publication
(10) Pub. No.: US 2016/0048801 A1
(43) Pub. Date: Feb. 18, 2016

(54) System and Method for Voice Activated Load Board Transactions

(71) Applicant: David Loftus, Beverly Hills, CA (US)

(72) Inventor: David Loftus, Beverly Hills, CA (US)

(21) Appl. No.: 14/828,498

(22) Filed: Aug. 17, 2015

Related U.S. Application Data
(60) Provisional application No. 62/038,317, filed on Aug. 17, 2014.

(51) Int. Cl. G06Q 10/08

(52) U.S. Cl. CPC G06Q 10/0835

(57) ABSTRACT

The present invention is directed to a voice operable system and method for identifying and matching a carrier, such as a trucker, and cargo for moving such cargo to a desired destination and for facilitating load board transactions. The present invention allows a carrier to identify prospective cargo loads in real time while transporting an existing load and while driving via voice communications and commands by the carrier into the automated system of the present invention. The system further allows for a shipper to identify prospective carriers and carrier details for its cargo. The system facilitates the carrier and cargo transaction by providing each party required and requested information concerning the carrier and the cargo. In addition, the system process the available data relating to the carrier, cargo, transportation routes and costs, timing, weather and calculates and provides detailed information allowing the parties to facilitate efficient and preferred load transportation.

### CROSS REFERENCE TO RELATED APPLICATION

The present application claims priority from and is entitled to the benefit of U.S. provisional patent application, Ser. No. 62/038317 entitled “System And Method For Voice Activated Load Board Transactions,” filed on Aug. 17, 2014, by inventor David Loftus, which is hereby incorporated by reference in its entirety into this disclosure.

### BACKGROUND

1. Field of the Invention

The present invention relates generally to the load board transactions and more specifically to a voice operated system and method of matching available carriers with cargo and freight to be transported in real and near real time.

2. Description of the Background Art

Load boards are information portals for the freight industry, allowing carriers (e.g., truckers) to find loads that need to be moved and shippers or freight brokers to find capacity for moving those loads. A load board may display both freight and freight capacity, allowing anyone reviewing the information on the load board to determine if their load or capacity needs can be met. For example, if a trucker with available capacity determines that a shipper has a load that can be transported by the trucker, the trucker and the shipper may come to an agreement to transport the load.

Currently, a trucker searches for his or her next load by accessing a load board after the trucker has completed delivery of a current load. Typically, load boards are accessed via the Internet or on monitors at truck stops. However, accessing a load board via the Internet is potentially illegal and generally impractical for a trucker on the road in that on-line applications for accessing load boards must be utilized while parked since using a mobile phone while driving without hands-free access is dangerous and can result in penalties, license suspension and fines. Also, accessing a load board from a monitor at a truck stop requires a trucker to find a truck stop having a working monitor, find parking, enter the truck stop, view the monitor and determine if it makes economic sense to transport the load and then communicate with the appropriate load board. This is a highly inefficient and oftentimes unavailable process.

### SUMMARY OF THE INVENTION

The present invention is directed to a computer implemented system and method for matching prospective truckers or carriers with a prospective loads of cargo (cargo). The invention includes one or more non-transitory computer readable media storing computer readable instructions that, when executed, cause the system to receiving information from a shipper about a prospective cargo load to be transported and from at least one carrier having interest in transporting a load to a desired destination. The system allows for creating an agreement between the carrier and the shipper authorizing the carrier to transportation the cargo upon agreed terms. The present invention allows a carrier to identify prospective cargo loads in real time while transporting an existing load and while driving via voice communications and commands by the carrier into the automated system of the present invention. The system further allows for a shipper to identify prospective carriers and carrier details for its cargo. The system facilitates the carrier and cargo transaction by providing each party required and requested information concerning the carrier and the cargo. In addition, the system process the available data relating to the carrier, cargo, transportation routes and costs, timing, weather and calculates and provides detailed information allowing the parties to facilitate efficient and preferred load transportation.

### BRIEF DESCRIPTION OF THE DRAWINGS

Embodiments of the invention are illustrated by way of example and not by way of limitation in the figures and diagrams of the accompanying drawings in which like references indicate similar elements. It should be noted that different references to “an” or “one” embodiment in this disclosure are not necessarily to the same embodiment, and such references mean at least one.

FIG. 1 shows a block diagram of a system for voice activated load board transactions according to an embodiment of the present invention.

FIG. 2 shows a flow diagram of a method for voice activated load board transactions according to an embodiment of the present invention.

### DETAILED DESCRIPTION

In the following description of preferred embodiments, reference is made to the accompanying drawings which form a part hereof, and in which are shown by way of illustration specific embodiments in which the invention may be practiced. It is to be understood that other embodiments may be utilized without departing from the scope of the present invention.

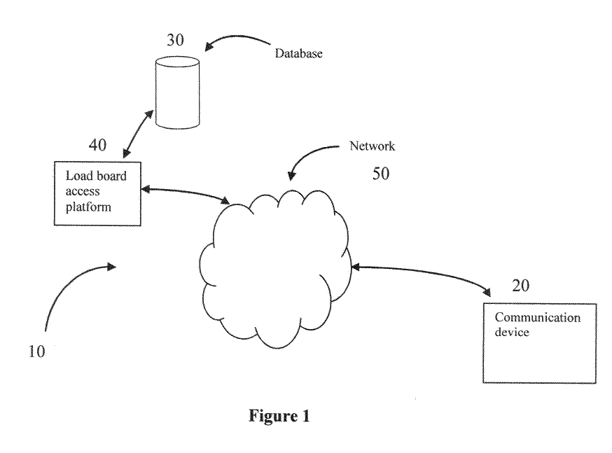

A system for voice activated load board transactions 10 according to an embodiment of the present invention is shown in FIG. 1. FIG. 1 includes, for example, a communication system or a communication device 20 and a load board access platform 40. The communication device 20 and the load board access platform 40 may both be connected to a network 50.

The network 50 may be a telephone or telecommunications network. For example, the network 50 may be a public or private network, a local area network or a wide area network, or may be the Internet. According to an embodiment of the present invention, the network 50 may be a wired network, such as a public switched telephone network, for example, which may include a network of physical wires like copper wires. Alternatively, the network 50 may be a network of fiber optic cables. According to another embodiment of the present invention, the network 50 may be a wireless telephone network such as the type used by mobile telephones in a cellular telephone system. According to another embodiment of the present invention, the network 50 may be a “WiFi” network or may be a voice over Internet protocol (VoIP) network. According to yet another embodiment of the present invention, the network 50 may be a combination of a wired network and a wireless network.

The communication device 20 may be any type of communication device with which a trucker (carrier) or other carrier may communicate with another person or another device. Alternatively, the communication device 20 may be a communication system. For example, according to an embodiment of the present invention, the communication device 20 may be a traditional analog telephone system. Alternatively, the communication device 20 may be a simple residential telephone, a cordless phone, a mobile telephone, a smartphone, a feature phone or any other communication device into which voice signals or voice commands can be spoken.

According to the embodiment of the invention shown in FIG. 1, if the Internet is part of the network 50, the communication device 20 may be communicatively coupled to a network adapter. The network adapter may be a VoIP adapter, configured to accept voice or analog signals and convert such signals to data suitable for transmission over a data network. VoIP adapters are well-known in the art. The network adapter is then communicatively coupled to the network 50 such that the communication device 20, through the network adapter, may access the network 50. According to yet another embodiment of the present invention, the communication device 20 may be configured as a personal computer, a laptop computer or a tablet computer with a downloadable voice-to-data application, such as SKYPE, for example, thereby providing a session initiation protocol (SIP) connection.

The load board access platform 40 shown in FIG. 1 may be a hosted application. For example, according to an embodiment of the present invention, the load board access platform 40 may include a software program that resides on a computer system such as a server, or a smartphone. The load board access platform 40 may be configured as a software-as-a-service application and may exist as a cloud-based application.

According to an embodiment of the present invention, the load board access platform 40 may include a computer system having a processor coupled to a memory, storage, a network interface and an I/O interface. The processor may be one or more microprocessors and may include other logic circuits. The memory may include RAM, ROM, DRAM, SRAM and the like, and may include firmware, such as static data or fixed instructions, BIOS, system functions, configuration data, and other routines used during the operation of the processor. The memory may also provide a storage unit for data and instructions associated with applications and data handled by the processor. The storage unit provides non-volatile long term storage of data or instructions in the computer system. The storage unit may take the form of a disk, optical storage, SAN, tape, CD, DVD, or other reasonably high capacity addressable storage medium. In addition, the load board access platform 40 may include one or more databases 30 in which information is stored and organized. The databases 30 may be relational databases, hierarchical databases, and the like. Alternatively, the load board access platform 40 may access an external database or a plurality of databases. For example the system may preferably access a number of external load boards as well as databases having information on interested party's licensing, payment and insurance information.

According to an embodiment of the present invention, the load board access platform 40 may be implemented as a website resident on a server computer. For example, the server computer may be programmed such that an application generates a website available to truckers, other carriers or any other person or entity over a network. According to an embodiment of the present invention, truckers or other carriers calling the load board access platform 40 may access the application hosted by the server computer via a website on the Internet.

According to yet another embodiment of the present invention, the load board access platform 40 may be hosted on telephony application servers or trunk servers that are communicatively coupled to the network 50. The telephony application servers or trunk servers may be configured for voice recognition and speech and may be referred to generically as speech servers. For example, if the network 50 is a wired or wireless telephone network 50, the load board access platform 40 may provide computer telephony integration such that truckers or other carriers placing a call via the communication device 20 to the load board access platform 40 may access speech servers implemented in the load board access platform 40 via the telephone network 50. In this configuration, the speech servers implemented in the load board access platform 40 may answer a call from the trucker or other carrier.

The load board access platform 40 may be configured such that it is capable of accessing load board data in databases through application programming interfaces (APIs). For example, the load board access platform 40 may communicate with a load board database via an API to determine various information about available loads, such as, for example, the name of the shipper's employer, the name of the owner of the load, the respective telephone numbers of the foregoing, the respective email addresses of the foregoing, the locations of various loads within a particular city, the type of load, the size of the loads, the refrigeration and freezing needs of the load, the destination of the load, the date and time the load needs to arrive at its destination, the amount of money being paid for transporting the load, and the like.

The load board access platform 40 may be configured such that it is capable of accessing other platforms and other data in databases through various APIs. For example, according to an embodiment of the present invention, data residing in databases regarding how long a trucker has been driving, what a shipper is paying to transport a particular load, and other information may be accessed by the load board access platform 40 using various APIs or other methods of interfacing to platforms and databases that are well-known in the art.

The load board access platform 40 may be configured such that it accepts enrollment by truckers or other carriers. According to an embodiment of the present invention, truckers or other carriers may enroll with the load board access platform 40 and enter information about themselves, their capacity to transport a load or freight, the nature of the load or freight, the location of the load or freight, the destination to which the load or freight must be transported, and the like. According to an embodiment of the present invention, the load board access platform 40 may register an identification (ID) number for the trucker, other carrier, shipper, freight broker and the like who enroll with the load board access platform 40. The ID number may be a telephone number used by such persons or organizations or may be another number or multiple numbers that all identify them. Once enrolled, the load board access platform 40 may accept information about the trucker or other carrier. The information may be stored and organized in one or more databases 30. For example, if a trucker were to enter information about himself into the database 30, such information may include the name of the trucker, his telephone number, his email address, the type of truck he drives, the capacity of the truck to carry loads or freight, the refrigeration and freezing capabilities of the truck has capability, the age of the truck, and the like. A trucker may also enter into the database 30 the trucker's TWITTER and FACEBOOK accounts so that the load board access platform 40 will have this information readily available. Such information may allow for enhanced communication between a trucker and a dispatcher, shipper or freight broker.

According to an embodiment of the present invention, the load board access platform 40 is preferably configured to utilize speech or voice recognition technology for entry of information and user commands. For example, the load board access platform 40 may be configured such that any information being entered into it, such as a telephone number or the name of a person or place, type of load and the like may be entered simply by a trucker or other carrier speaking into his or her telephone.

According to an embodiment of the present invention, the load board access platform 40 may be configured such that when a trucker or other carrier calls the load board access platform 40 using the communication device 20, the load board access platform 40 connects to the communication device 20 via the network 50. The load board platform 40 preferably recognizes the device 20 of that of the carrier. The load board platform 40 may require the user to confirm their identity and authorization. For example, the system platform 40 may require the carrier to state its user identification name or number and a password. Once authorized, the system logs into the account belonging to the trucker or other carrier and provides direct communication via voice. The load board access platform 40 may also log on and authorize access to the account using a “caller ID,” “media access control (mac) ID,” or other identification mechanism associated with the communication device 20 as are well-known in the art along with voice recognition of the individual carrier or an approved voice for a multiple carrier.

According to an embodiment of the present invention, a trucker or other carrier may enroll for service with the load board access platform 40 by accessing a website associated with the load board access platform 40. Once at the website, the trucker or other carrier may enter his or her mobile phone number or other preferred identification such as a user name, for example. Once the trucker has provided the system 10 with a preferred mobile number, the load board access platform 40 may then send a text message or other type of message to the mobile phone 20 belonging to the trucker or other carrier that includes an access number (e.g. the provided mobile number) and a personal identification means such as a personal identification number (PIN), password or other identification means as are well known with websites and mobile applications. After receipt of the access number and the password or PIN, the trucker or other carrier can then dial the access number using his or her mobile phone and enter the password. The password will then be associated with the mobile phone of the trucker or other carrier and the trucker or other carrier will be able to automatically utilize the services provided by the load board access platform 40 simply by dialing the access number from the mobile phone to which the access number and PIN were sent. According to another embodiment of the present invention, the trucker or other carrier will be able to automatically utilize the services provided by the load board access platform 40 simply by depressing a speed dial key on the mobile phone to which the access number and PIN were sent. According to yet another embodiment of the present invention, the trucker may access the load bard access 40 by simply activating an application on their smartphone via touch or voice activation.

A variety of other methods may be used to enroll or register for service with the load board access platform 40. For example, a trucker or other carrier may download an application, such as a mobile application, for example, to the mobile phone, tablet computer, personal computer or the like belonging to the trucker or other carrier. The application may be configured such that, as soon as the application is opened, the application automatically dials an access number for the load board access platform 40, thereby automatically connecting the trucker or other carrier to the load board access platform 40. According to another embodiment of the present invention, the application may be configured such that, as soon as the application is opened, a key is made available which, when pressed, causes the application to dial an access number for the load board access platform 40, thereby connecting the trucker or other carrier to the load board access platform 40. The trucker or other carrier may then configure his or her account in any manner offered by the load board access platform 40.

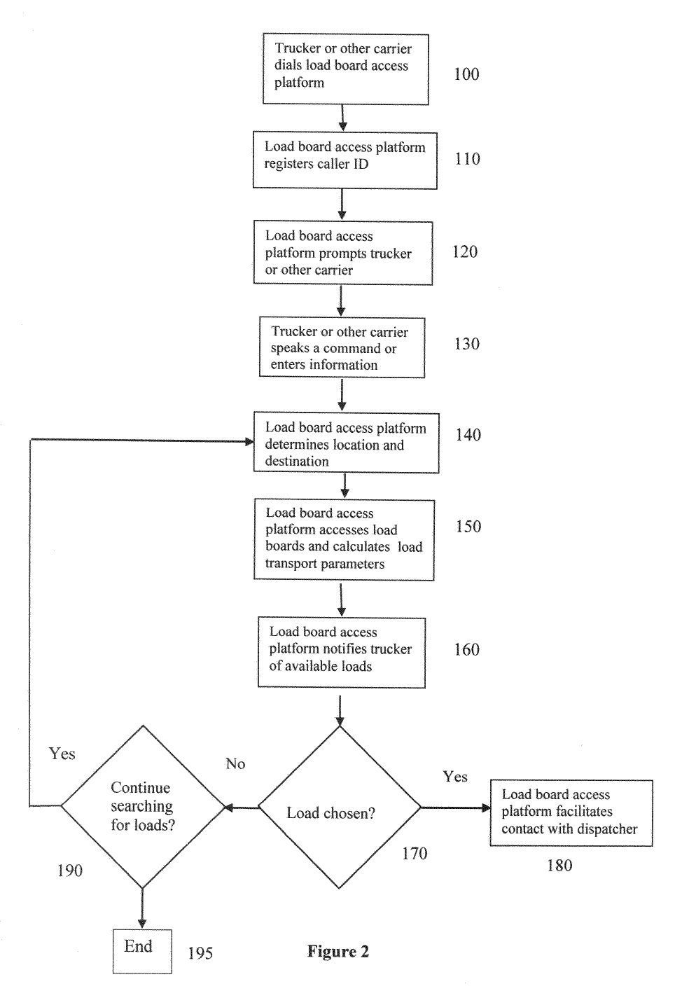

A method for voice activated load board transactions according to an embodiment of the present invention is shown in FIG. 2. While making reference to FIG. 2, reference will continue to be made to FIG. 1. In FIG. 2, at step 100 a trucker or other carrier dials into a load board access platform 40. The trucker or other carrier may dial into the load board access platform 40 from any type of telephone and from any location using voice commands. For example, the trucker or other carrier may dial from a mobile telephone, a smartphone, a feature phone, an analog telephone, such as a landline telephone, or the like. Also, the trucker or other carrier may dial into the load board access platform 40 from home, an office, while away from the home or the office, or from any other place that the trucker or other carrier is able to make a telephone call. According to an embodiment of the present invention, a trucker may dial into the load board access platform 40 with his or her mobile phone using a hands-free connection while transporting a load. Such an embodiment is particularly efficient for a trucker in that the trucker may be able to transact for his or her next load before completing the delivery of the load he or she is currently transporting, thereby allowing the trucker to plan efficiently and eliminate expensive downtime.

Once the trucker or other carrier has dialed into the load board access platform 40, at step 110 the trucker or other carrier registers with the load board access platform 40. The trucker or other carrier may register with the load board access platform 40 in a variety of ways. For example, according to an embodiment of the present invention, the trucker or other carrier may enter his or her login credentials directly into the telephone for identification by the load board access platform 40. Entry of the login credentials may be accomplished in a variety of ways. For example, the trucker or other carrier may enter login credentials by using the telephone's touch-tone keypad or may press a pre-programmed speed dial key. Alternatively, the trucker or other carrier may enter login credentials by speaking them directly into the telephone for identification by the load board access platform 40. According to another embodiment of the present invention, the trucker or other carrier's login credentials may be identified by the load board access platform 40 automatically by recognizing the telephone or phone number from which the trucker or other carrier is calling, or by recognizing the voice or spoken username or password of the trucker or other carrier.

Once the trucker or other carrier's login credentials have been identified and the trucker or other carrier is logged into the load board access platform 40, at step 120 the load board access platform 40 prompts the trucker or other carrier to speak a command or enter information. In response to the prompt from the load board access platform 40, at step 130 the trucker or other carrier speaks a command or enters information into the load board access platform 40 by, for example, simply speaking into the telephone.

For example, according to an embodiment of the present invention, a trucker may, using voice commands, use his or her mobile phone to dial into the load board access platform and may say something like “find loads,” “find freight,” “find jobs,” or the like. In response to this information entered by the trucker, at step 140, the load board access platform 40 may attempt to determine the location of the trucker by issuing a query to the trucker such as “where are you now” or “where are you going” or something similar. Alternatively, the load board access platform 40 may determine the location of the trucker by utilizing a global positioning system (GPS) function on the trucker's mobile phone. For example, if a trucker is driving toward Houston, Texas, to deliver freight, and the trucker dials into the load board access platform 40 to attempt to find his next load, the load board access platform 40 may ask the trucker, “Where are you going?”, to which the trucker may respond, “Houston, Tex.” Next, the load board access platform may issue a query by saying, “Where are you now?”, to which the trucker would respond with his or her location. Alternatively, the load board access platform 40 may use GPS to determine the trucker's position. With this information now available, the load board access platform 40 may find a new load for the trucker.

At step 150, load board access platform 40, now having information about the current location and destination of the trucker, begins automatically accessing load board data from one or more load board data servers using an API or APIs, for example, to determine various loads that would be available for transport by the trucker. Alternatively, the load board access platform 40 may include its own internal load board. Once the load board access platform 40 has accessed load board data, the load board access platform 40 may calculate various parameters regarding the transporting of the load based on the location of the trucker. For example, according to an embodiment of the present invention, the load board access platform 40 may determine which loads fall into the qualification parameters of the trucker, such as, for example, when a particular load must arrive at its destination; whether the trucker has the capacity for the load; whether the trucker will physically be able to deliver the load within the necessary time parameters based on the trucker's current location, the length of time it will take to reach the location of the load, the length of time it will take to deliver the load based on driving time, road conditions, weather, road closures, road construction, mandated rest and sleep breaks, and the like; the fees payable for transporting the load; and other parameters related to the transporting of the load. Once the load board access platform 40 has determined which loads the trucker can qualify for, at step 160 the load board access platform 40 notifies the trucker of one or more loads available for transporting.

For example, once the trucker has accessed the load board access platform 40, the load board access platform 40 may calculate that the trucker is two hours from the trucker's destination of Houston, Texas using global positioning information as is well known in the art, including receiving such information from the trucker's smartphone. Thus, the load board access platform 40 may begin accessing load board data bases and determine that there are five prospective cargo loads, for example, currently available to the trucker for transporting to the trucker's next destination within the next two hours and that meet the trucker's prerequisites. The load board access platform 40 may indicate to the trucker the length of time it will take to deliver the load, how much it will cost to deliver the load, how much the job will pay, including pay per mile of transport, estimated fuel consumption and cost, and the like. As the trucker approaches his or destination, such as Houston, Texas in this example, the load board access platform 40 may update the trucker, for example, when he or she is one hour outside of Houston, Texas. The load board access platform 40 may then indicate that some new loads are available for pick up and transport, or may indicate that a particular load is no longer available to the trucker. In a preferred embodiment, the load board access platform provides the currently available loads in order or calculated desirability based on information provided to the system by the trucker (both upon signing up for the service with the system as well as during the recent communications with the system).

Once the trucker is aware of the loads available for pick up and transport, at step 170 the trucker may or may not decide to choose to contract for a load. If the trucker does not choose one of the loads available, the load board access platform 40 may ask the trucker at step 190 if he or she would like to continue searching for loads. If the trucker chooses to continue searching, the load board access platform 40 continues with the process at step 140 to determine where the trucker is, where the trucker is going, and what loads may be available to the trucker when the trucker reaches his or her destination. If the trucker decides to not continue searching, according to an embodiment of the present invention the process may end at step 195.

It the trucker does choose one of the loads available, at step 180 the load board access platform 40 provides contact and communications between the trucker and a dispatcher, shipper or freight broker. At this point, the trucker and the dispatcher, shipper or freight broker can enter into a contract for transporting the load, which may also be completely handled or just facilitated by the load board access platform 40. The load board access platform 40 may, for example, provide the prospective cargo broker or other with information on the trucker, including vehicle and river information and license authorizations along with insurance and permit information. Once the trucker has picked up the load and is off to the delivery destination, the trucker may again engage the load board access platform 40 to efficiently find his or her next load. Alternatively, the load board access platform 40 may contact the trucker with updated information concerning the cargo being transported.

While particular embodiments of the present invention have been shown and described, it will be obvious to those skilled in the art that the invention is not limited to the particular embodiments shown and described and that changes and modifications may be made without departing from the spirit and scope of the invention.

1. A computer implemented method for matching a prospective carrier with a prospective load comprising the following steps:
receiving information from a shipper about a prospective cargo load to be transported;
receiving information from a prospective carrier about interest and availability to transport cargo and associating the carrier with information about the carrier;
calculating information about the cargo and the requested cargo destination, including route information, estimated costs and driving times and providing such information to the carrier;
communicating with the carrier about the prospective cargo using voice communications;
facilitating a transaction such that the carrier enters into an agreement to transport the cargo to a desired destination.

2. The computer implemented method of claim 1 further comprising the step of identifying the carrier by voice recognition.

3. The computer implemented method of claim 1 further comprising the step of communicating with the carrier through a mobile communication device.

4. The computer implemented method of claim 1 wherein the mobile communication device is a smart phone.

5. The computer implemented method of claim 1 further comprising the step of providing the shipper with information about the carrier's ability to transport the cargo to the desired location.

6. The computer implemented method of claim 1 further comprising the step of receiving information from load board databases to further identify additional cargo available for the carrier.

7. The computer implemented method of claim 6 further comprising the step of providing the carrier different prospective cargo for transport in order of preference as calculated from carrier input preferences.

8. The computer implemented method of claim 1 wherein the step of receiving information from a shipper comprises receiving information from a load board.

9. The computer implemented method of claim 8 wherein the step of receiving information from a shipper comprises receiving information from a plurality of shippers from a load board.

10. The computer implemented method of claim 8 wherein the step of receiving information from a shipper comprises receiving information from a plurality of load boards.

11. The computer implemented method of claim 1 wherein the step of receiving information from a carrier comprises receiving information from a plurality of carriers.

12. The computer implemented method of claim 1 wherein the step of receiving information from a carrier comprises receiving information through voice commands from the carrier.

13. The computer implemented method of claim 1 further comprising the step of limiting the identification of prospective cargo loads to the carrier.

14. The computer implemented method of claim 1 further comprising the step of authorizing an agreement between the carrier and the shipper for transportation of the cargo upon agreed terms.

15. The computer implemented method of claim 1 wherein the method comprises a load board that communicates with carries through voice communications.

16. One or more non-transitory computer readable media storing computer readable instructions that, when executed, cause a system to:
receive information from a carrier sufficient to identify the carrier and associating the carrier with information about the carrier that is stored on at least one of the computers;
receive information about a load of cargo sufficient to identify the cargo and the shippery requesting the cargo be transported and associating the cargo with details of its requested transportation from an origin to a destination and offered payment;
calculate prospective details of transaction between the carrier and the cargo;
calculate at least one preferred transportation route along with estimated transportation time and transportation costs associated with the carrier and the cargo, and providing the carrier information on the cargo and offering the carrier the opportunity to transport the cargo as requested by the shipper,
providing information in the carrier to the shipper, and
providing information to the shipper that the carrier has picked up the cargo.

17. The one or more computer readable media of claim 16, wherein the computer readable instructions are provided by voice command.

18. The one or more computer readable media of claim 16 wherein, the computer readable instructions, when executed, further cause the system to communicate with the carrier through a smart phone.

19. The one or more computer readable media of claim 17 wherein, the computer readable instructions, when executed, further cause the system to communicate with the carrier through a mobile phone.

20. The one or more computer readable media of claim 17 wherein, the computer readable instructions, when executed, further cause the system to at least partially confirm the identity of the carrier using voice recognition.
